(19) United States
(12) Patent Application Publication
(10) Pub. No.: US 2010/0028563 A1
(43) Pub. Date: Feb. 4, 2010

(54) Method of forming carbon film, method of manufacturing magnetic recording medium, and apparatus for forming carbon film

(75) Inventor: Ichiro OTA, Jurong (SG)

Correspondence Address: SUGHRUE MION, PLLC, 2100 PENNSYLVANIA AVENUE, N.W., SUITE 800, WASHINGTON, DC, 20037, US

(73) Assignee: Showa Denko HD Singapore Pte. Ltd., Jurong (SG)

(21) Appl. No.: 12/505,919

(22) Filed: Jul. 20, 2009

(30) Foreign Application Priority Data
Jul. 23, 2008 (JP) 2008-190066

(51) Int. Cl. G11B 5/84

(52) U.S. Cl. 427/580; 118/722

(57) ABSTRACT

The present invention provides a carbon film forming method capable of forming a dense carbon film with high hardness. The carbon film forming method includes: introducing a raw material gas G including carbon into a deposition chamber 101 whose internal pressure is reduced; ionizing the raw material gas G using a discharge between a filament-shaped cathode electrode 104 heated by electrical power and an anode electrode 105 provided around the cathode electrode; and accelerating and radiating the ionized gas to the surface of a substrate D. A magnetic field is applied by a permanent magnet 109 to increase the ion density of the ionized gas accelerated and radiated to the surface of the substrate D. In this way, it is possible to form a carbon film with high hardness and high density on the surface of the substrate D.

### BACKGROUND

1. Technical Field

The present invention relates to a method of forming a carbon film, a method of manufacturing a magnetic recording medium, and an apparatus for forming a carbon film.

Priority is claimed on Japanese Patent Application No. 2008-190066, filed Jul. 23, 2008, the content of which is incorporated herein by reference.

2. Background Art

In recent years, in the field of magnetic recording media used in, for example, hard disk drives (HDDs), recording density has improved significantly at a rate of about 100 times per 10 years. There are many techniques available in order to improve the recording density. One of the key technologies is to control the sliding characteristics between the magnetic head and the magnetic recording medium.

For example, a CSS (contact start-stop) system, which is also called the Winchester system, in which a basic operation from the start to the end of the operating of a magnetic head including contact/sliding, the flying of the head, and contact/sliding with respect to the magnetic recording medium, has been mainly used for the hard disk drive. Therefore, contact and sliding of the magnetic head on the magnetic recording medium are inevitable.

Therefore, in recent years, the tribology problem between the magnetic head and the magnetic recording medium has become the key technical problem which needs to be solved. There has been an attempt to improve the performance of the protective film formed on the magnetic film of the magnetic recording medium, and the abrasion resistance and sliding resistance of the surface of the magnetic recording medium are the key factors in improving the reliability of the magnetic recording medium.

Films made of various materials have been proposed as the protective film of the magnetic recording medium. However, generally, a carbon film has been used as the protective film due to, for example, its durability and film forming properties. In addition, for example, the hardness, density, and dynamic friction coefficient of the carbon film are very important since they are reflected to the CSS characteristics or corrosion resistance characteristics of the magnetic recording medium.

It is preferable to reduce the flying height of the magnetic head and increase the number of rotations of the recording medium in order to improve the recording density of the magnetic recording medium. Therefore, in order to cope with accidental contact of the magnetic head, the protective film formed on the surface of the magnetic recording medium needs to be flat and have a high resistance to sliding. In addition, in order to reduce the spacing loss between the magnetic recording medium and the magnetic head so as to improve the recording density, it is necessary to reduce the thickness of the protective film so as to make it as small as possible. For example, it is necessary to reduce the thickness of the protective film to 30 Å or less. In addition, there is strong demand for a flat, thin, dense and strong protective film.

The carbon film used as the protective film of the magnetic recording medium is formed by, for example, a sputtering method, a CVD method, or an ion beam deposition method. Among these methods, when the carbon film is formed with a thickness of, for example, 100 Å or less by the sputtering method, the durability of the carbon film is likely to be insufficient. When the carbon film formed by the CVD method has low flatness and a small thickness, the coverage over the surface of the magnetic recording medium is lowered, and the magnetic recording medium is likely to corrode. The ion beam deposition method can form a dense carbon film with high hardness and high flatness, as compared to the sputtering method and the CVD method.

As a method of forming a carbon film using the ion beam deposition method, for example, the following method has been proposed: a method of changing a film forming material gas into plasma using a discharge between a filament-shaped cathode that is heated and an anode and accelerating the ionized gas to collide with the surface of a substrate having a negative potential, thereby stably forming a carbon film with high hardness in a deposition chamber in a vacuum atmosphere (see Patent Document 1 (JP-A-2000-226659)).

However, in order to further improve the recording density of the magnetic recording medium, it is necessary to further reduce the thickness of the carbon film. The method disclosed in Patent Document 1 increases the temperature of a filament so as to increase the amount of anode current, and increases the ion acceleration voltage so as to increase the hardness of the carbon film. However, there are limitations in the method. The characteristics of the formed carbon film cannot be improved even when the anode current is increased to a predetermined value or more. In addition, when the anode current is excessively large, an abnormal discharge occurs in an excitation space, which causes the thickness of the formed carbon film to be non-uniform or the filament to break. When the temperature of the filament is excessively high, there is a concern that the filament will break, or the filament material will be evaporated and mixed with the carbon film.

The present invention has been made in order to solve the above-mentioned problems, and an object of the present invention is to provide a carbon film forming method capable of forming a dense carbon film with high hardness.

Another object of the present invention is to provide a magnetic recording medium manufacturing method capable of providing a magnetic recording medium that includes the carbon film formed by the carbon film forming method as a protective layer and which has high abrasion resistance and high corrosion resistance.

Still another object of the present invention is to provide a carbon film forming apparatus capable of forming a dense carbon film with high hardness.

### SUMMARY OF THE INVENTION

The inventors have conducted research to solve the above-mentioned problems and found that it is possible to form a carbon film with high hardness and high density on the surface of a substrate by introducing a raw material gas which includes carbon into a deposition chamber whose internal pressure is reduced, ionizing the raw material gas using a discharge between a filament-shaped cathode electrode heated by electrical power and an anode electrode provided around the cathode electrode, and applying a magnetic field from the outside when the ionized gas is accelerated and radiated to the surface of the substrate, thereby increasing the ion density of the ionized gas accelerated and radiated to the surface of the substrate.

That is, the present invention provides the following means.

According to a first aspect of the present invention, there is provided a method of forming a carbon film. The method includes: introducing a raw material gas which includes carbon into a deposition chamber whose internal pressure is reduced; ionizing the gas using a discharge between a filament-shaped cathode electrode heated by electrical power and an anode electrode provided around the cathode electrode; and accelerating and radiating the ionized gas to the surface of a substrate to form the carbon film on the surface of the substrate. A magnetic field is applied in a region in which the raw material gas is ionized or a region in which the ionized gas is accelerated.

According to a second aspect of the present invention, in the method of forming a carbon film according to the first aspect, the magnetic field may be applied by a permanent magnet that is provided around the cathode electrode and the anode electrode.

According to a third aspect of the present invention, in the method of forming a carbon film according to the first or second aspect, the magnetic field may be applied such that in a direction in which the ionized gas is accelerated is substantially parallel to the direction of the magnetic field lines of the permanent magnet.

According to a fourth aspect of the present invention, in the method of forming a carbon film according to any one of the first to third aspects, there may be a potential difference between the cathode electrode or the anode electrode and the substrate, and the ionized gas may be radiated to the surface of the substrate while being accelerated.

According to a fifth aspect of the present invention, there is provided a method of manufacturing a magnetic recording medium. The method includes forming a carbon film on a non-magnetic substrate with at least a magnetic layer formed thereon, using the method of forming a carbon film according to any one of the first to fourth aspects.

According to a sixth aspect of the present invention, an apparatus for forming a carbon film includes: a deposition chamber whose internal pressure can be reduced; a holder that holds a substrate in the deposition chamber; an introduction pipe that introduces a raw material gas which includes carbon into the deposition chamber; a filament-shaped cathode electrode that is provided in the deposition chamber; an anode electrode that is provided around the cathode electrode in the deposition chamber; a first power supply that supplies electrical power to heat the cathode electrode; a second power supply that generates a discharge between the cathode electrode and the anode electrode; a third power supply that generates a potential difference between the cathode electrode or the anode electrode and the substrate; and a permanent magnet that applies a magnetic field between the cathode electrode and the anode electrode or the substrate.

According to the present invention, it is possible to form a dense carbon film with high hardness. For example, when the carbon film is used as a protective film of a magnetic recording medium, it is possible to reduce the thickness of the carbon film and thus reduce the distance between the magnetic recording medium and the magnetic head. As a result, it is possible to increase the recording density of the magnetic recording medium and increase the corrosion resistance of the magnetic recording medium.

### BRIEF DESCRIPTION OF THE DRAWINGS

FIG. 1 is a diagram schematically illustrating the structure of an apparatus for forming a carbon film according to the present invention.

FIG. 2A is a diagram schematically illustrating the magnetic field applied by a permanent magnet and the direction of the magnetic field lines of the permanent magnet.

FIG. 2B is a diagram schematically illustrating the magnetic field applied by a permanent magnet and the direction of the magnetic field lines of the permanent magnet.

FIG. 2C is a diagram schematically illustrating the magnetic field applied by permanent magnets and the direction of the magnetic field lines of the permanent magnets.

FIG. 3 is a cross-sectional view illustrating an example of a magnetic recording medium manufactured according to the present invention.

FIG. 4 is a cross-sectional view illustrating another example of the magnetic recording medium manufactured according to the present invention.

FIG. 5 is a cross-sectional view illustrating an example of a magnetic recording/reproducing apparatus.

FIG. 6 is a plan view illustrating the structure of an in-line film forming apparatus according to the present invention.

FIG. 7 is a side view illustrating carriers of the in-line film forming apparatus according to the present invention.

FIG. 8 is an enlarged side view illustrating the carrier shown in FIG. 7.

FIG. 9 is a characteristic diagram illustrating Raman spectroscopy results according to examples of the present invention.

FIG. 10 is a characteristic diagram illustrating scratch test results according to the examples of the present invention.

FIG. 11 is a characteristic diagram illustrating corrosion test results according to the examples of the present invention.

### BEST MODE FOR CARRYING OUT THE INVENTION

Hereinafter, exemplary embodiments of the present invention will be described in detail with reference to the accompanying drawings.

In the following drawings, for convenience of explanation, in some cases, characteristic parts are enlarged for ease of understanding, and the dimensions and scale of each component may be different from the actual dimensions and scale.

First, a method and apparatus for forming a carbon film according to the present invention will be described.

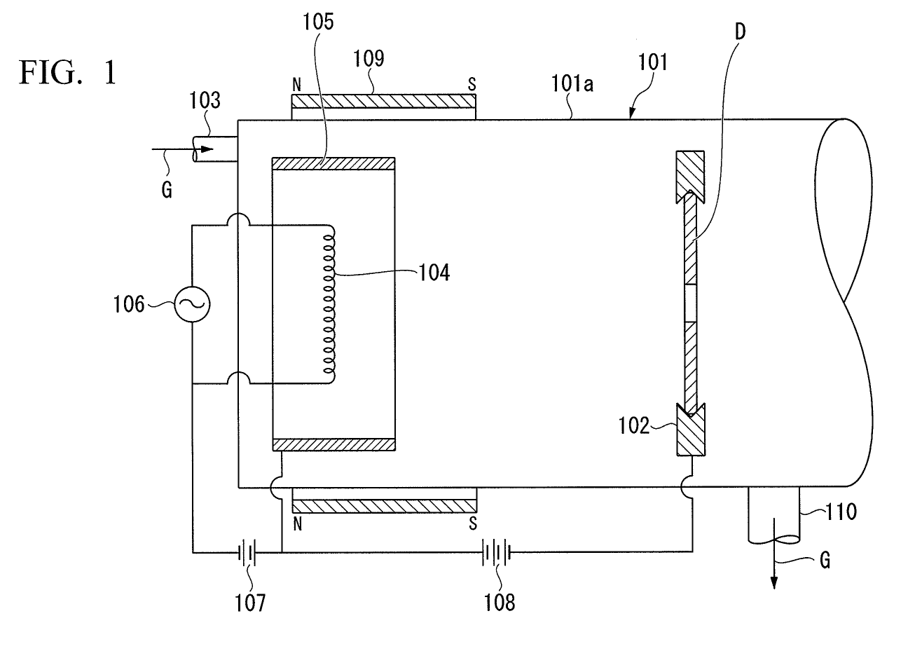

FIG. 1 is a diagram schematically illustrating the structure of the carbon film forming apparatus according to the present invention.

As shown in FIG. 1, the carbon film forming apparatus is a film forming apparatus using an ion beam deposition method, and includes a deposition chamber 101 whose internal pressure can be reduced, a holder 102 that holds a substrate D in the deposition chamber 101, an introduction pipe 103 that introduces a raw material gas G which includes carbon into the deposition chamber 101, a filament-shaped cathode electrode 104 that is provided in the deposition chamber 101, an anode electrode 105 that is provided around the cathode electrode 104 in the deposition chamber 101, a first power supply 106 that supplies electrical power to heat the cathode electrode 104, a second power supply 107 that generates a discharge between the cathode electrode 104 and the anode electrode 105, a third power supply 108 that generates a potential difference between the cathode electrode 104 or the anode electrode 105 and the substrate D, and a permanent magnet 109 that applies a magnetic field between the cathode electrode 104 and the anode electrode 105 or the substrate D.

The deposition chamber 101 is configured of a chamber wall 101a so as to be airtight, and the internal pressure thereof can be reduced through an exhaust pipe 110 connected to a vacuum pump (not shown). The first power supply 106 is an AC power supply that is connected to the cathode electrode 104, and supplies electrical power to the cathode electrode 104 during the formation of a carbon film. In addition, the first power supply 106 is not limited to the AC power supply, but it may be a DC power supply. The second power supply 107 is a DC power supply having a negative electrode connected to the cathode electrode 104 and a positive electrode connected to the anode electrode 105, and generates a discharge between the cathode electrode 104 and the anode electrode 105 during the formation of the carbon film. The third power supply 108 is a DC power supply having a positive electrode connected to the anode electrode 105 and a negative electrode connected to the holder 102 and generates a potential difference between the anode electrode 105 and the substrate D held by the holder 102 during the formation of the carbon film. In the third power supply 108, the positive electrode may be connected to the cathode electrode 104.

In the present invention, the voltage and current of the first to third power supplies depend on the size of the substrate D. For example, when a carbon film is formed on a disk-shaped substrate having an outside diameter of 3.5 inches, it is preferable that the voltage of the first power supply 106 be in the range of 10 to 100 V and the DC or AC current thereof be in the range of 5 to 50 A. It is preferable that the voltage of the second power supply 107 be in the range of 50 to 300 V and the current thereof be in the range of 10 to 5000 mA. It is preferable that the voltage of the third power supply 108 be in the range of 30 to 500 V and the current thereof be in the range of 10 to 200 mA.

When a carbon film is formed on the surface of the substrate D by the carbon film forming apparatus having the above-mentioned structure, the raw material gas G which includes carbon is introduced into the deposition chamber 101 whose pressure is reduced through the exhaust pipe 110 through the introduction pipe 103. The raw material gas G is excited and decomposed into an ionized gas (carbon ions) by the thermal plasma of the cathode electrode 104 heated by the electrical power supplied from the first power supply 106 and the plasma generated by the discharge between the anode electrode 105 and the cathode electrode 104 connected to the second power supply 107. Then, the excited carbon ions in the plasma collide with the surface of the substrate D while being accelerated toward the substrate D with a negative potential by the third power supply 108.

In the method of forming a carbon film according to the present invention, a magnetic field is applied by the permanent magnet 109 arranged around the chamber wall 101a in a region in which the raw material gas G is ionized or a region in which the ionized gas (referred to as ion beams) is accelerated (hereinafter, referred to as an excitation space).

In the present invention, when the carbon ions are accelerated and radiated to the surface of the substrate D, it is possible to increase the ion density of the carbon ions accelerated and radiated to the surface of the substrate D by applying a magnetic field from the outside. When the ion density in the excitation space is increased in this way, an excitation force in the excitation space is increased. Therefore, it is possible to accelerate and radiate the carbon ions with higher energy to the surface of the substrate D. As a result, it is possible to form a carbon film with high hardness and high density on the surface of the substrate D.

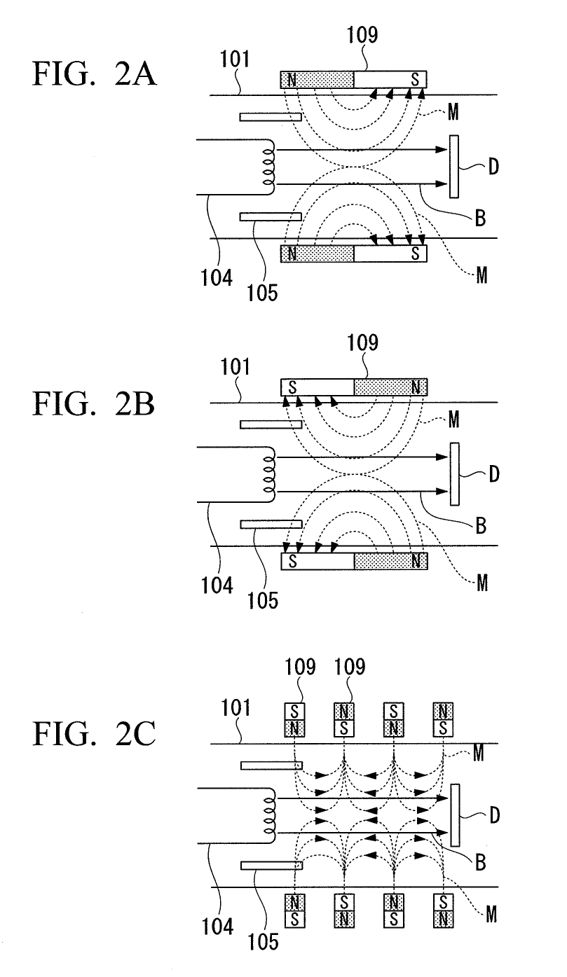

In the present invention, it is possible to apply a magnetic field to the excitation space in the deposition chamber 101 by using the permanent magnet 109 that is provided around the cathode electrode 104 and the anode electrode 105. For example, the permanent magnet 109 may be configured such that the magnetic field and the magnetic field lines of the permanent magnet are generated as shown in FIGS. 2A to 2C.

That is, in the structure shown in FIG. 2A (the same structure as that shown in FIG. 1), the permanent magnet 109 is provided around the chamber wall 101a of the deposition chamber 101 such that the S pole is close to the substrate D and the N pole is close to the cathode electrode 104. In this structure, the magnetic field lines M generated by the permanent magnet 109 are substantially parallel to the direction in which ion beams B are accelerated in the vicinity of the center of the deposition chamber 101. When the direction of the magnetic field lines M is set in the deposition chamber 101 in this way, the carbon ions in the excitation space are concentrated substantially on the center of the deposition chamber 101 by the magnetic moment thereof. Therefore, it is possible to effectively increase the ion density in the excitation space.

In the structure shown in FIG. 2B, the permanent magnet 109 is provided around the chamber wall 101a of the deposition chamber 101 such that the S pole is close to the cathode electrode 104 and the N pole is close to the substrate D. In the structure shown in FIG. 2C, a plurality of permanent magnets 109 are provided around the chamber wall 101a of the deposition chamber 101 such that the N pole and the S pole are alternately arranged on the inner circumferential side and the outer circumferential side. In both cases, the magnetic field lines M generated by the permanent magnet 109 are substantially parallel to the direction in which the ion beams B are accelerated in the vicinity of the center of the deposition chamber 101. In this way, it is possible to effectively increase the ion density in the excitation space.

In the method of forming a carbon film according to the present invention, for example, a raw material gas which includes carbon hydride may be used as the raw material gas G which includes carbon. It is preferable that one or more kinds of lower carbon hydride selected from lower saturated carbon hydride, lower unsaturated carbon hydride, and lower cyclic carbon hydride be used as the carbon hydride. The term ‘lower’ means that the number of carbon atoms is in the range of 1 to 10.

Among the above-mentioned materials, for example, methane, ethane, propane, butane, or octane may be used as the lower saturated carbon hydride. In addition, for example, isoprene, ethylene, propylene, butylene, or butadiene may be used as the lower unsaturated carbon hydride. For example, benzene, toluene, xylene, styrene, naphthalene, cyclohexane, or cyclohexadiene may be used as the lower cyclic carbon hydride.

In the present invention, it is preferable to use a lower carbon hydride. The reason is as follows. When the number of carbon atoms in the carbon hydride is greater than the above-mentioned range, it is difficult to supply the carbon hydride as gas through the introduction pipe 103 and to decompose the carbon hydride during the discharge. As a result, the carbon film includes a large amount of polymer component with low strength.

In the present invention, it is preferable that, for example, a mixed gas including an inert gas or a hydrogen gas be used as the raw material gas G which includes carbon in order to generate plasma in the deposition chamber 101. It is preferable that the mixture ratio of the carbon hydride to the inert gas in the mixed gas be in the range of 2:1 to 1:100 (volume ratio). In this case, it is possible to form a carbon film with high hardness and high durability.

As described above, in the present invention, in the film forming apparatus using the ion beam deposition method, the raw material gas G which includes carbon is introduced into the pressure-reduced deposition chamber 101, and the raw material gas G is ionized by the discharge between the filament-shaped cathode electrode 104 that is heated by the electrical power and the anode electrode 105 provided around the cathode electrode 104. When the ionized gas is accelerated and radiated to the surface of the substrate D, the magnetic field is applied from the outside to increase the ion density of the ionized gas that is accelerated and radiated to the surface of the substrate D. In this way, it is possible to form a dense carbon film with high hardness on the surface of the substrate D.

In the carbon film forming apparatus shown in FIG. 1, the carbon film is formed on only one surface of the substrate D. However, the carbon films may be formed on both surfaces of the substrate D. In this case, the same apparatus structure as that when the carbon film is formed on only one surface of the substrate D may be provided at both sides of the substrate D in the deposition chamber 101.

Next, a method of manufacturing a magnetic recording medium according to the present invention will be described.

In this embodiment, an example will be described in which an in-line film forming apparatus that performs a film forming process while sequentially transporting a substrate, which is a deposition target, between a plurality of deposition chambers is used to manufacture a magnetic recording medium to be mounted on a hard disk device.

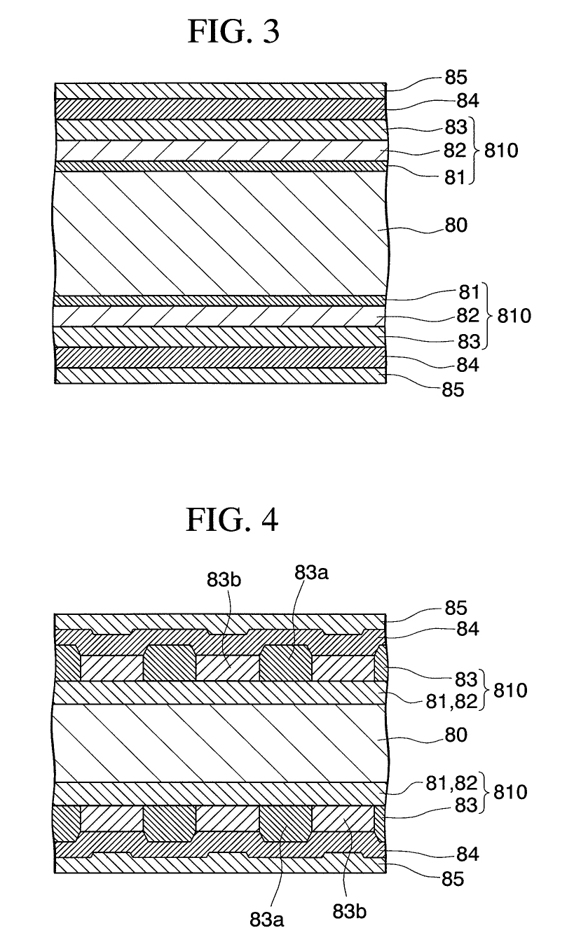

As shown in FIG. 3, the magnetic recording medium manufactured according to the present invention has, for example, a structure in which soft magnetic layers 81, intermediate layers 82, recording magnetic layers 83, and protective layers 84 are sequentially formed on both surfaces of a non-magnetic substrate 80 and lubrication layers 85 are formed on the outermost surfaces. The soft magnetic layer 81, the intermediate layer 82, and the recording magnetic layer 83 form a magnetic layer 810.

In the magnetic recording medium, a dense carbon film with high hardness is formed as the protective layer 84 by the method of forming a carbon film according to the present invention. In this case, in the magnetic recording medium, it is possible to reduce the thickness of the carbon film. Specifically, it is possible to reduce the thickness of the carbon film to about 2 nm or less.

Therefore, in the present invention, it is possible to reduce the distance between the magnetic recording medium and the magnetic head. As a result, it is possible to increase the recording density of the magnetic recording medium and increase the corrosion resistance of the magnetic recording medium.

Next, layers other than the protective layer 84 in the magnetic recording medium will be described.

As the non-magnetic substrate 80, any of the following non-magnetic substrates may be used: an Al alloy substrate made of, for example, an Al-Mg alloy having Al as a main component; and substrates made of general soda glass, aluminosilicate-based glass, crystallized glass, silicon, titanium, ceramics, and various kinds of resins.

It is preferable to use an Al alloy substrate, a glass-based substrate, such as the crystallized glass substrate, or a silicon substrate among the above-mentioned substrates. The average surface roughness (Ra) of these substrates is preferably equal to or less than 1 nm, more preferably, equal to or less than 0.5 nm, and most preferably, equal to or less than 0.1 nm.

The magnetic layer 810 may be an in-plane magnetic layer for an in-plane magnetic recording medium or a perpendicular magnetic layer for a perpendicular magnetic recording medium. However, it is preferable that the magnetic layer 810 be a perpendicular magnetic layer in order to obtain higher recording density. In addition, it is preferable that the magnetic layer 810 be made of an alloy having Co as the main component. For example, the magnetic layer 810 for a perpendicular magnetic recording medium may include the soft magnetic layer 81 made of a soft magnetic alloy, such as a FeCo alloy (for example, FeCoB, FeCoSiB, FeCoZr, FeCoZrB, or FeCoZrBCu), a FeTa alloy (for example, FeTaN or FeTaC), or a Co alloy (for example, CoTaZr, CoZrNB, or CoB), the intermediate layer 82 made of, for example, Ru, and the recording magnetic layer 83 made of, for example, a 60Co-15Cr-15Pt alloy or a 70Co-5Cr-15Pt-10SiO₂ alloy, which are laminated in this order. In addition, an orientation control film made of, for example, Pt, Pd, NiCr, or NiFeCr may be formed between the soft magnetic layer 81 and the intermediate layer 82. Meanwhile, the magnetic layer 810 for an in-plane magnetic recording medium may include a non-magnetic CrMo underlying layer and a ferromagnetic CoCrPtTa magnetic layer laminated in this order.

The overall thickness of the magnetic layer 810 is equal to or greater than 3 nm and equal to or less than 20 nm, preferably, equal to or greater than 5 nm and equal to or less than 15 nm n, and the magnetic layer 810 may be formed such that sufficient head input and output are obtained according to a laminated structure and the kind of magnetic alloy used. The thickness of the magnetic layer 810 needs to be equal to or greater than a certain value in order to obtain a predetermined output or more during reproduction. All parameters indicating recording/reproduction characteristics generally deteriorate as the output is increased. Therefore, it is necessary to set the optimal thickness.

As a lubricant used for the lubrication film 85, a fluorine-based liquid lubricant, such as perfluoropolyether (PFPE), or a solid lubricant, such as fatty acid, may be used. In general, the lubrication layer 85 is formed with a thickness of 1 to 4 nm. The lubricant may be applied by a known method, such as a dipping method or a spin coating method.

As another magnetic recording medium manufactured according to the present invention, for example, as shown in FIG. 4, a so-called discrete-type magnetic recording medium may be used in which magnetic recording patterns 83a formed in the recording magnetic layer 83 are separated by non-magnetic regions 83b.

As the discrete-type magnetic recording medium, a so-called patterned medium in which the magnetic recording pattern 83a is regularly arranged for each bit or a medium in which the magnetic recording pattern 83a is arranged in a track shape may be used. In addition, the magnetic recording pattern 83a may include, for example, a servo signal pattern.

The discrete-type magnetic recording medium is obtained by providing a mask layer on the surface of the recording magnetic layer 83 and performing a reactive plasma process or an ion beam process on a portion that is not covered by the mask layer so as to change a portion of the recording magnetic layer 83 from a magnetic body into a non-magnetic body, thereby forming the non-magnetic region 83b.

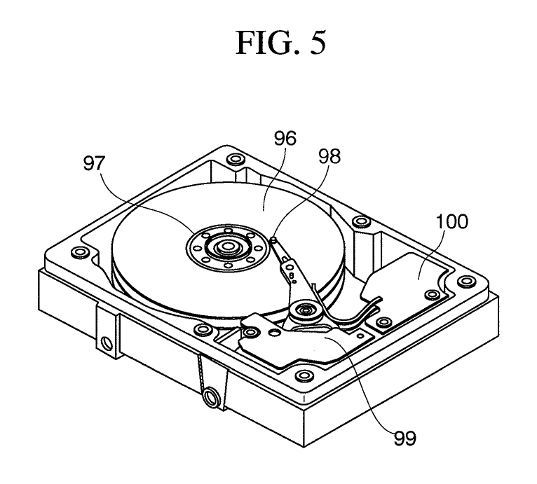

In addition, for example, a hard disk device shown in FIG. 5 may be used as a magnetic recording/reproducing apparatus using the magnetic recording medium. The hard disk device includes a magnetic disk 96, which is the magnetic recording medium, a medium driving unit 97 that rotates the magnetic disk 96, a magnetic head 98 that records information on and reproduces information from the magnetic disk 96, a head driving unit 99, and a recording/reproduction signal processing system 100. The magnetic reproduction signal processing system 100 processes input data, transmits a recording signal to the magnetic head 98, processes the reproduction signal from the magnetic head 98, and outputs data.

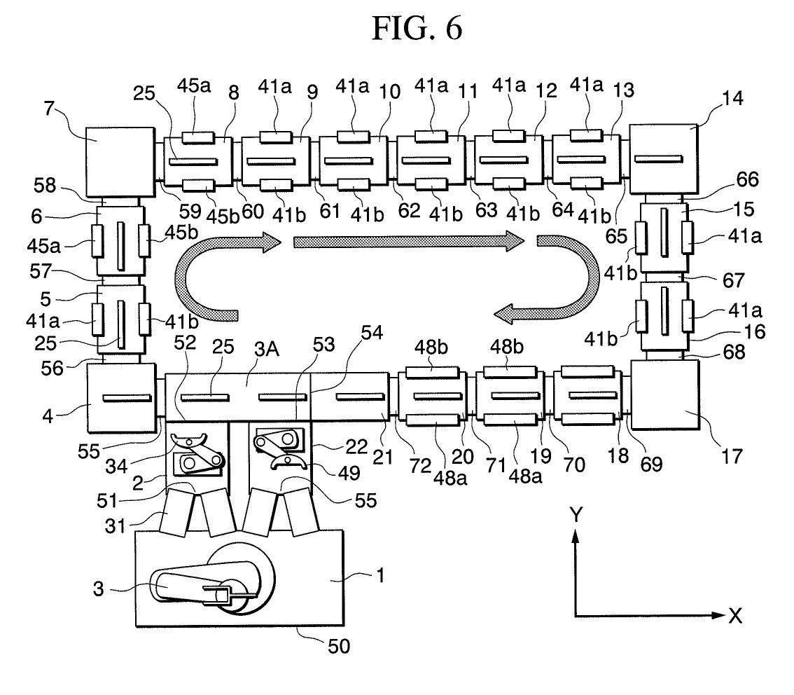

When the magnetic recording medium is manufactured, for example, the in-line film forming apparatus (an apparatus for manufacturing a magnetic recording medium) according to the present invention shown in FIG. 6 is used to sequentially form the magnetic layers 810, each having at least the soft magnetic layer 81, the intermediate layer 82, and the recording magnetic layer 83, and the protective layers 84 on both surfaces of the non-magnetic substrate 80, which is a deposition target, thereby stably manufacturing the magnetic recording medium having a dense carbon film with high hardness, as the protective layer 84.

Specifically, the in-line film forming apparatus according to the present invention includes: a robot table 1; a substrate cassette moving robot 3 that is provided on the robot table 1; a substrate supply robot chamber 2 that is provided adjacent to the robot table 1; a substrate supply robot 34 that is provided in the substrate supply robot chamber 2; a substrate attaching chamber 52 that is provided adjacent to the substrate supply robot chamber 2; corner chambers 4, 7, 14, and 17 that rotate carriers 25; processing chambers 5, 6, 8 to 13, 15, 16, and 18 to 20 that are provided between the corner chambers 4, 7, 14, and 17; a substrate detaching chamber 54 that is provided adjacent to the processing chamber 20; an ashing chamber 3A that is provided between the substrate attaching chamber 52 and the substrate detaching chamber 54; a substrate detaching robot chamber 22 that is provided adjacent to the substrate detaching chamber 54; a substrate detaching robot 49 that is provided in the substrate detaching robot chamber 22; and a plurality of carriers 25 that are transported among the chambers.

Each of the chambers 2, 52, 4 to 20, 54, and 3A is connected to two adjacent walls, and gate valves 55 to 71 are provided in connection portions between the chambers 2, 52, 4 to 20, 54, and 3A. When the gate valves 55 to 71 are closed, the chambers become individual enclosed spaces.

Each of the chambers 2, 52, 4 to 20, 54, and 3A is connected to a vacuum pump (not shown). The carrier 25 is sequentially transported into each chamber, whose internal pressure is reduced by the vacuum pump, by a transport mechanism (not shown), and the soft magnetic layer 81, the intermediate layer 82, the recording magnetic layer 83, and the protective layer 84 are sequentially formed on both surfaces of the non-magnetic substrate 80 that is mounted on the carrier 25 in each chamber. Finally, the magnetic recording medium shown in FIG. 3 is obtained. Each of the corner chambers 4, 7, 14, and 17 changes the movement direction of the carrier 25, and has a mechanism that rotates the carrier 25 and moves it to the next deposition chamber.

The substrate cassette moving robot 3 supplies the non-magnetic substrate 80 to be subjected to deposition from a cassette having the non-magnetic substrate 80 accommodated therein to the substrate attaching chamber 2, and takes out the non-magnetic substrate 80 (magnetic recording medium) having the films formed thereon which is detached from the substrate detaching chamber 22. Openings communicating with the outside and the gate valves 51 and 55 that open or close the openings are provided in one wall of each of the substrate attaching/detaching chambers 2 and 22.

In the substrate attaching chamber 52, the substrate supply robot 34 is used to attach the non-magnetic substrate 80 to be subjected to deposition to the carrier 25. In the substrate detaching chamber 54, the substrate detaching robot 49 is used to detach the non-magnetic substrate 80 (magnetic recording medium) having films formed thereon from the carrier 25. The ashing chamber 3A performs ashing on the carrier 25 transported from the substrate detaching chamber 54 and then transports the carrier 25 to the substrate attaching chamber 52.

Among the processing chambers 5, 6, 8 to 13, 15, 16, and 18 to 20, the processing chambers 5, 6, 8 to 13, 15, and 16 are a plurality of deposition chambers for forming the magnetic layer 810. The deposition chambers have mechanisms for forming the soft magnetic layers 81, the intermediate layers 82, and the recording magnetic layers 83 on both surfaces of the non-magnetic substrate 80.

The processing chambers 18 to 20 are deposition chambers for forming the protective layer 84. The deposition chambers include the same apparatus structure as that of the deposition apparatus using the ion beam deposition method shown in FIG. 1, and form a dense carbon film having high hardness as the protective layer 84 on the surface of the non-magnetic substrate 80 having the magnetic layer 810 formed thereon.

When the magnetic recording medium shown in FIG. 4 is manufactured, the processing chambers may further include a patterning chamber that patterns a mask layer, a modifying chamber that performs a reactive plasma process or an ion beam process on a portion of the recording magnetic layer 83 that is not covered by the patterned mask layer so as to change a portion of the recording magnetic layer 83 from a magnetic body into a non-magnetic body, thereby forming the magnetic recording patterns 83b separated by the non-magnetic regions 83b, and a removing chamber that removes the mask layer.

Each of the processing chambers 5, 6, 8 to 13, 15, 16, and 18 to 20 is provided with a processing gas supply pipe, and a valve, whose opening or closing is controlled by a control mechanism (not shown), is provided in the supply pipe. The valves and the gate valves for pumps are opened or closed so as to control the supply of gas from the processing gas supply pipe, the internal pressures of the chambers, and the discharge of gas.

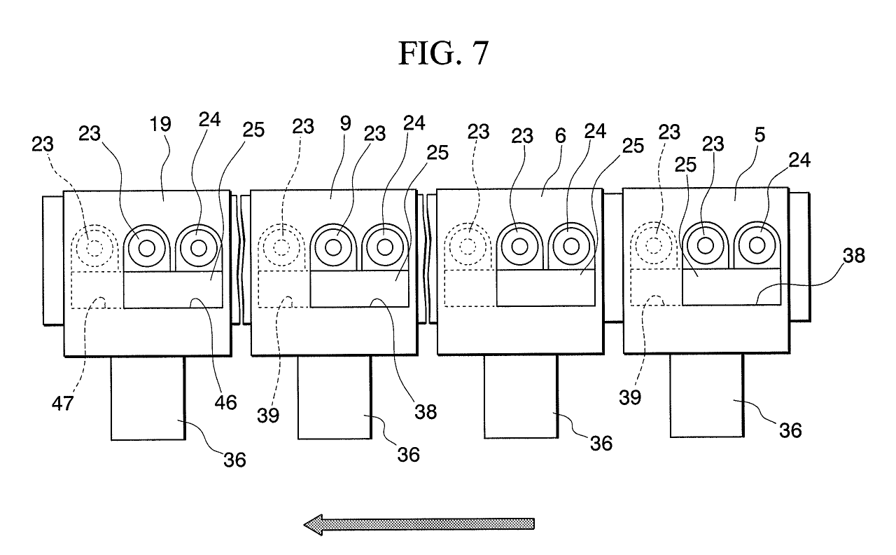

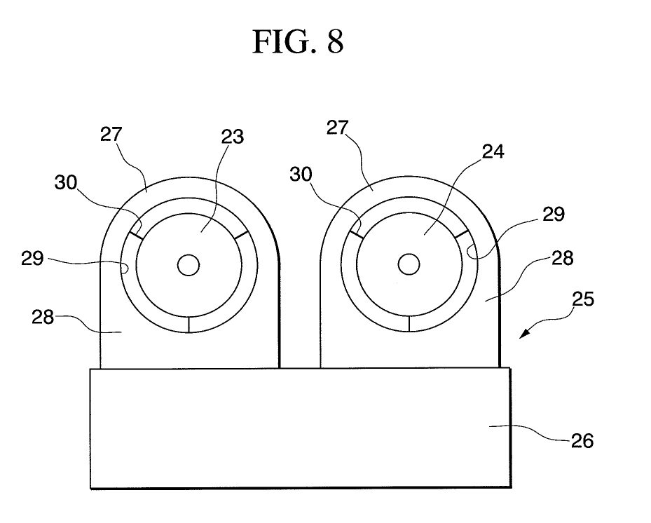

As shown in FIGS. 7 and 8, the carrier 25 includes a supporting table 26 and a plurality of substrate mounting portions 27 provided on the upper surface of the supporting table 26. In this embodiment, two substrate mounting portions 27 are provided. Therefore, two non-magnetic substrates 80 mounted to the substrate mounting portions 27 are treated as a first deposition substrate 23 and a second deposition substrate 24.

The substrate mounting portion 27 includes a plate 28 with a thickness that is equal to or several times more than the thickness of each of the first and second deposition substrates 23 and 24, a circular through hole 29 that is formed in the plate 28 and has a diameter slightly larger than the outer circumference of each of the deposition substrates 23 and 24, and a plurality of supporting members 30 that are provided around the through hole 29 so as to protrude to the inside of the through hole 29. In the substrate mounting portions 27, the first and second deposition substrates 23 and 24 are fitted into the through holes 29, and the edges of the first and second deposition substrates are engaged with the supporting members 30. In this way, the deposition substrates 23 and 24 are perpendicularly held (with the main surfaces of the substrates 23 and 24 being parallel to the direction of gravity). That is, the substrate mounting portions 27 are provided in parallel to the upper surface of the supporting table 26 such that the main surfaces of the first and second deposition substrates 23 and 24 mounted on the carrier 25 are substantially perpendicular to the upper surface of the supporting table 26.

In addition, in the processing chambers 5, 6, 8 to 13, 15, 16, and 18 to 20, two processing devices are provided on both sides of the carrier 25. In this case, for example, a deposition process is performed on the first deposition substrate 23 arranged on the left side of the carrier 25 that stops at a first process position represented by a solid line in FIG. 7, and the carrier 25 is moved to a second process position represented by a dashed line in FIG. 7. Then, the deposition process is performed on the second deposition substrate 24 arranged on the right side of the carrier 25 that stops at the second process position.

When four processing devices are provided at both sides of the carrier 25 so as to face the first and second deposition substrates 23 and 24, it is not necessary to move the carrier 25, and it is possible to perform a deposition process on the first and second deposition substrates 23 and 24 held by the carrier 25 at the same time.

After the deposition process, the first and second deposition substrates 23 and 24 are detached from the carrier 25, and only the carrier 25 having a carbon film formed thereon is transported into the ashing chamber 3A. Then, an oxygen gas is introduced into the ashing chamber 3A through an arbitrary portion of the ashing chamber, and the oxygen gas is used to generate oxygen plasma in the ashing chamber 3A. When the oxygen plasma contacts the carbon film formed on the surface of the carrier 25, the carbon film is decomposed and removed by CO or CO₂ gas.

### EXAMPLES

Hereinafter, the effects of the present invention are made more apparent by the following examples. The present invention is not limited to the following examples, but various modifications and changes of the present invention can be made without departing from the scope of the present invention.

### Example 1

In Example 1, first, an aluminum substrate plated with NiP was prepared as a non-magnetic substrate. Then, the in-line film forming apparatus shown in FIG. 6 was used to sequentially form soft magnetic layers that were made of FeCoB and had a thickness of 60 nm, intermediate layers that were made of Ru and had a thickness of 10 nm, and recording magnetic layers that were made of a 70Co-5Cr-15Pt-10SiO₂ alloy and had a thickness of 15 nm, thereby forming magnetic layers on both surfaces of the non-magnetic substrate that was mounted on a carrier made of A5052 aluminum alloy. Then, the non-magnetic substrate mounted on the carrier was transported into a processing chamber having the same apparatus structure as that of the film forming apparatus shown in FIG. 1, and protective layers, which were carbon films, were formed on both surfaces of the non-magnetic substrate having the magnetic layers formed thereon.

Specifically, the processing chamber had a cylindrical shape with an outside diameter of 180 mm and a length of 250 mm. The chamber wall of the processing chamber was made of SUS304. A coil-shaped cathode electrode that had a length of about 30 mm and was made of tungsten and a cylindrical anode electrode surrounding the cathode electrode were provided in the processing chamber. The anode electrode was made of SUS304 and had an outside diameter of 140 mm and a length of 40 mm. In addition, the distance between the cathode electrode and the non-magnetic substrate was 160 mm. In addition, a cylindrical permanent magnet was arranged so as to surround the chamber wall. The permanent magnet had an inside diameter of 185 mm and a length of 40 mm, and was arranged such that the anode electrode was disposed at the center of the permanent magnet, the S pole was close to the substrate, and the N pole was close to the cathode electrode. The total magnetic force of the permanent magnet was 50 G (5 mT).

A toluene gas was used as the raw material gas. The carbon film was formed with a thickness of 3.5 nm under the following deposition conditions: a gas flow rate of 2.9 SCCM; a reaction pressure of 0.3 Pa; a cathode power of 225 W (AC 22.5 V and 10 A); a voltage between the cathode electrode and the anode electrode: 75 V; a current of 1650 mA; an ion acceleration voltage of 200 V and a current of 60 mA.

### Examples 2 and 3

In Example 2, a magnetic recording medium was manufactured under the same conditions as those in Example 1 except that the carbon film was formed with a thickness of 3 nm. In Example 3, a magnetic recording medium was manufactured under the same conditions as those in Example 1 except that the carbon film was formed with a thickness of 2.5 nm.

### Comparative Examples 1 to 3

In Comparative example 1, a magnetic recording medium was manufactured under the same conditions as those in Example 1 except that no permanent magnet was provided in the processing chamber for forming a carbon film and the carbon film was formed with a thickness of 3.5 nm. In Comparative example 2, a magnetic recording medium was manufactured under the same conditions as those in Example 1 except that no permanent magnet was provided in the processing chamber for forming a carbon film and the carbon film was formed with a thickness of 3 nm. In Comparative example 3, a magnetic recording medium was manufactured under the same conditions as those in Example 1 except that no permanent magnet was provided in the processing chamber for forming a carbon film and the carbon film was formed with a thickness of 2.5 nm.

### (Evaluation of Magnetic Recording Media)

Raman spectroscopy, scratch tests, and corrosion tests were performed on the magnetic recording media according to Examples 1 to 3 and Comparative examples 1 to 3.

For the Raman spectroscopy, a Raman spectrometer manufactured by JEOL was used to measure B/A, where B indicates the intensity of the peak of the Raman spectrum and A indicates the intensity of the peak when base line correction is performed. As the value of B/A is reduced, the amount of polymer component in the carbon film is reduced, and the hardness of the carbon film is increased.

In the scratch test, an SAF tester manufactured by Kubota Corporation was used. The experimental conditions were as follows: a magnetic recording medium was rotated at 12000 rpm; a PP6 head was used to repeatedly seek the surface of a disk for two hours at a speed of 5 inches/sec; and an optical microscope was used to check whether there was a scratch on the surface.

In the corrosion test, the magnetic recording medium was left for 96 hours at a temperature of 90° C. and a humidity of 90%, and an optical surface tester was used to count the number of corrosion spots on the surface of the magnetic recording medium.

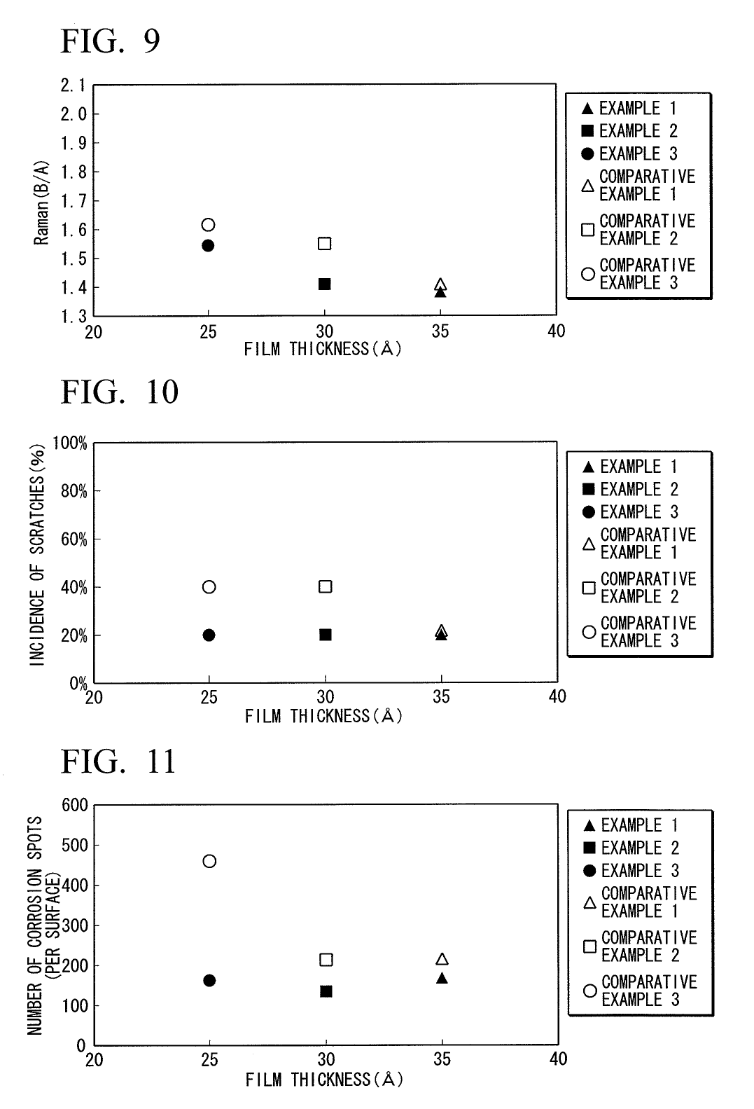

The measurement results of the Raman spectroscopy, the scratch tests, and the corrosion tests for the magnetic recording media according to Examples 1 to 3 and Comparative examples 1 to 3 are shown in FIGS. 9, 10, and 11, respectively.

As can be seen from the Raman spectroscopy results shown in FIG. 9, when the film forming apparatus according to the present invention is used, a carbon film having a small B/A is obtained. That is, the magnetic recording medium manufactured according to the present invention has a hard carbon film with a large amount of sp3 component.

As can be seen from the scratch test results shown in FIG. 10, when the film forming apparatus according to the present invention is used, a hard carbon film is obtained which is less likely to be scratched even when the thickness of the carbon film is reduced.

As can be seen from the corrosion test results shown in FIG. 11, when the film forming apparatus according to the present invention is used, the occurrence of corrosion is reduced even when the thickness of the carbon film is reduced. That is, the carbon film of the magnetic recording medium manufactured according to the present invention is dense and has high corrosion resistance.

While preferred embodiments of the present invention have been described above, the present invention is not limited thereto. However, additions, omissions, substitutions, and other modifications can be made without departing from the spirit and scope of the present invention. Accordingly, the present invention is not to be considered as being limited by the foregoing description, and is only limited by the scope of the appended claims.

1. A method of forming a carbon film, comprising:
introducing a raw material gas including carbon into a deposition chamber whose internal pressure is reduced;
ionizing the gas using a discharge between a filament-shaped cathode electrode heated by electrical power and an anode electrode provided around the cathode electrode; and
accelerating and radiating the ionized gas to the surface of a substrate to form the carbon film on the surface of the substrate,
wherein a magnetic field is applied in a region in which the raw material gas is ionized or a region in which the ionized gas is accelerated.

2. The method of forming a carbon film according to claim 1,
wherein the magnetic field is applied by a permanent magnet that is provided around the cathode electrode and the anode electrode.

3. The method of forming a carbon film according to claim 1,
wherein the magnetic field is applied such that a direction in which the ionized gas is accelerated is substantially parallel to the direction of the magnetic field lines of the permanent magnet.

4. The method of forming a carbon film according to claim 1,
wherein there is a potential difference between the cathode electrode or the anode electrode and the substrate, and
the ionized gas is radiated to the surface of the substrate while being accelerated.

5. A method of manufacturing a magnetic recording medium, comprising:
forming a carbon film on a non-magnetic substrate having at least a magnetic layer formed thereon, using the method of forming the carbon film according to claim 1.

6. An apparatus for forming a carbon film comprising:
a deposition chamber whose internal pressure can be reduced;
a holder that holds a substrate in the deposition chamber;
an introduction pipe that introduces a raw material gas including carbon into the deposition chamber;
a filament-shaped cathode electrode that is provided in the deposition chamber;
an anode electrode that is provided around the cathode electrode in the deposition chamber;
a first power supply that supplies electrical power to heat the cathode electrode;
a second power supply that generates a discharge between the cathode electrode and the anode electrode;
a third power supply that generates a potential difference between the cathode electrode or the anode electrode and the substrate; and
a permanent magnet that applies a magnetic field between the cathode electrode and the anode electrode or the substrate.

7. The method of forming a carbon film according to claim 2,
wherein the magnetic field is applied such that a direction in which the ionized gas is accelerated is substantially parallel to the direction of the magnetic field lines of the permanent magnet.

8. The method of forming a carbon film according to claim 2,
wherein there is a potential difference between the cathode electrode or the anode electrode and the substrate, and
the ionized gas is radiated to the surface of the substrate while being accelerated.

9. A method of manufacturing a magnetic recording medium, comprising:
forming a carbon film on a non-magnetic substrate having at least a magnetic layer formed thereon, using the method of forming the carbon film according to claim 2.
